(19) United States
(12) Patent Application Publication
(10) Pub. No.: US 2013/0327554 A1
(43) Pub. Date: Dec. 12, 2013

(54) POWER TOOL

(71) Applicant: Milwaukee Electric Tool Corporation, Brookfield, WI (US)

(72) Inventors: Steven W. Hyma, Milwaukee, WI (US); Scott D. Bublitz, Hartland, WI (US); Jason R. Crowe, Milwaukee, WI (US)

(21) Appl. No.: 13/916,500

(22) Filed: Jun. 12, 2013

Related U.S. Application Data
(60) Provisional application No. 61/658,533, filed on Jun. 12, 2012.

(51) Int. Cl. B25F 5/02

(52) U.S. Cl. CPC B25F 5/02
USPC 173/47

(57) ABSTRACT

A power tool includes a chuck assembly having a driveline axis. A motor housing extends from an end cap portion to a drive end. The end cap portion includes an end cap bumper coupled to the end cap portion that extends radially outward with respect to the driveline axis. A handle extends from the motor housing along a handle axis and defines a battery receptacle. A mode selector ring is rotatably coupled to the housing assembly about the driveline axis between the chuck assembly and the motor housing drive end. The mode selector ring includes a drive end bumper extending radially outward with respect to the driveline axis. The power tool may rest upon a flat surface with only the end cap bumper and drive end bumper contacting the surface when a battery pack is inserted into the battery receptacle.

### CROSS-REFERENCE TO RELATED APPLICATIONS

This application claims priority to U.S. Provisional Patent Application No. 61/658,533, filed Jun. 12, 2012, the entire contents of which are incorporated herein by reference.

### BACKGROUND

The present invention relates to power tools, and in particular, the invention relates to a power tool housing.

Power tools, such as drills, hammer-drills, and drill-drivers are used in a variety of work environments. Allowing a power tool to slide across a work surface can result in marring of the work surface and potential damage to the tool.

### SUMMARY

In one embodiment, the invention provides a power tool. A chuck assembly defines a driveline axis. A housing assembly rotatably supports the chuck assembly and includes a handle portion disposed along a handle axis and defining a battery receptacle, and a motor housing portion including a side wall extending from an end cap portion to a drive end. An end cap bumper is coupled to the end cap portion adjacent the side wall and extends radially outward with respect to the driveline axis. A mode selector ring is rotatably coupled to the housing assembly about the driveline axis, between the chuck assembly and the motor housing portion drive end. A drive end bumper is coupled to the mode selector ring and extends radially outward with respect to the driveline axis from the mode selector ring. A battery pack is at least partially received by the battery receptacle. The battery pack has a base portion including a battery bumper member extending radially outward from the handle axis. A plane defined by the end cap bumper, the drive end bumper, and the battery bumper is not intersected by any other portion of the power tool.

In another embodiment the invention provides a power tool. A chuck assembly defines a driveline axis. A motor housing rotatably supports the chuck assembly and extends from an end cap portion to a drive end. The end cap portion includes an end cap bumper that extends radially outward with respect to the driveline axis. A handle extends from the motor housing along a handle axis and defines a battery receptacle for receiving a battery. A mode selector ring is rotatably coupled to the housing assembly about the driveline axis between the chuck assembly and the motor housing drive end. The mode selector ring includes a drive end bumper extending radially outward with respect to the driveline axis. The power tool may rest upon a flat surface with only the end cap bumper and drive end bumper contacting the surface when a battery pack is inserted into the battery receptacle.

Other aspects of the invention will become apparent by consideration of the detailed description and accompanying drawings.

### BRIEF DESCRIPTION OF THE DRAWINGS

FIG. 1 is a perspective view of a power tool according to one construction of the invention.

FIG. 2 is a different perspective view of the power tool of FIG. 1

FIG. 3 is a front view of the power tool of FIG. 1.

FIG. 4 is a bottom view of the power tool of FIG. 1.

FIG. 5 is a perspective view of a power tool according to another construction of the invention.

FIG. 6 is a different perspective view of the power tool of FIG. 5

FIG. 7 is a front view of the power tool of FIG. 5.

FIG. 8 is a bottom view of the power tool of FIG. 5.

FIG. 9 is a perspective view of a power tool according to another construction of the invention.

FIG. 10 is a different perspective view of the power tool of FIG. 9.

FIG. 11 is a front view of the power tool of FIG. 9.

FIG. 12 is a bottom view of the power tool of FIG. 9.

FIG. 13 is a perspective view of a power tool according to another construction of the invention.

FIG. 14 is a different perspective view of the power tool of FIG. 13.

FIG. 15 is a front view of the power tool of FIG. 13.

FIG. 16 is a bottom view of the power tool of FIG. 13.

FIG. 17 is a perspective view of a power tool according to yet another construction of the invention.

FIG. 18 is a different perspective view of the power tool of FIG. 17.

FIG. 19 is a front view of the power tool of FIG. 17.

FIG. 20 is a bottom view of the power tool of FIG. 17.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

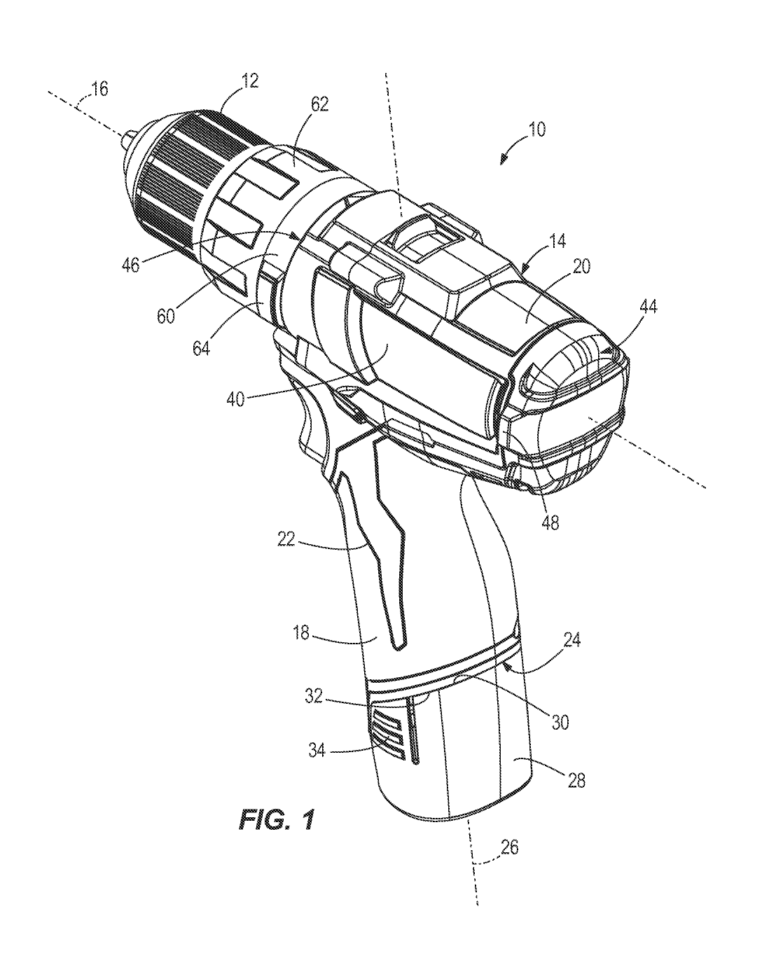

FIG. 1 illustrates a power tool 10, such as, e.g., a drill-driver. The power tool 10 includes a chuck assembly 12 and a housing assembly 14. The chuck assembly defines a driveline axis 16 and is rotatably supported by the housing assembly 14. The housing assembly 14 includes a handle portion 18 and a motor housing portion 20.

The handle portion 18 is contoured to receive a user's grip during operation of the power tool 10. The handle portion 18 may be formed with a resilient over-mold 22. The handle portion 18 defines a battery receptacle 24 along a handle axis 26 for receiving a battery or battery pack 28.

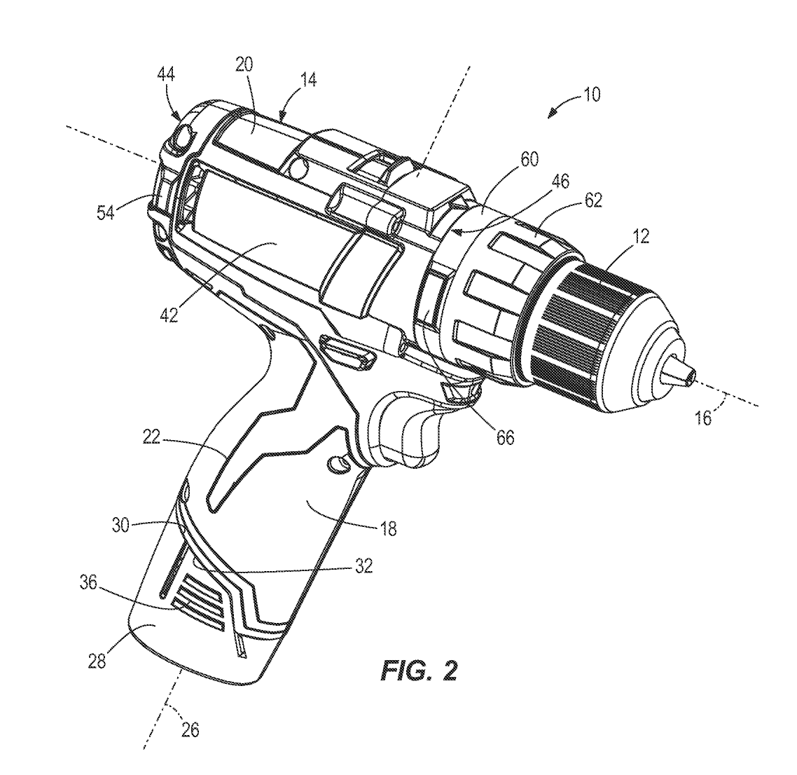

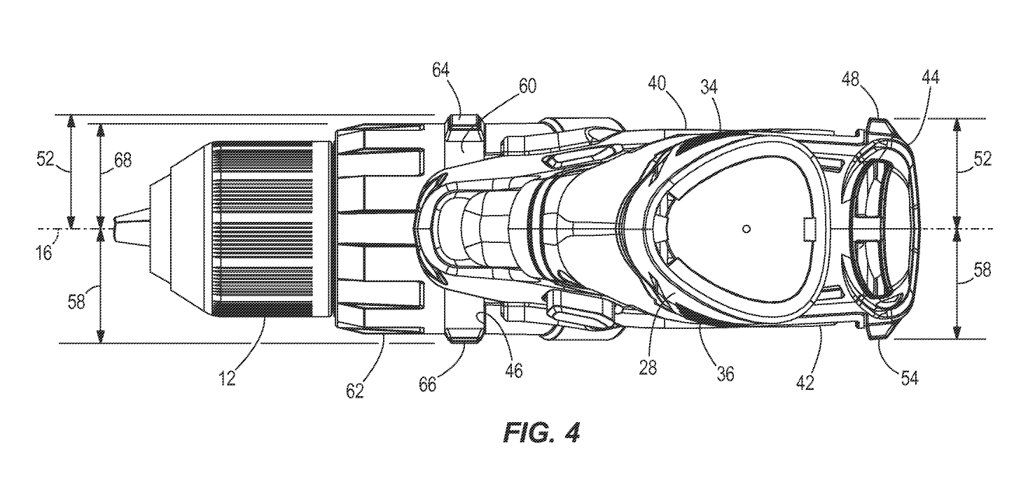

The battery receptacle 24 is configured to receive, for example, a 12 volt, lithium-ion rechargeable battery pack 28. The battery pack 28 includes a base portion 30 contoured to matingly engage corresponding contours of an end portion 32 of the housing handle portion 18 of FIG. 1. A resilient first battery bumper 34 (FIG. 1) and a resilient second battery bumper 36 (FIG. 2) are coupled to the base portion 30. The first battery bumper 34 and second battery bumper 36 each extend substantially perpendicular to the battery handle axis 26 and the driveline axis 16 (FIG. 4).

The motor housing portion 20 includes a first side wall 40 (FIG. 1) and a second side wall 42 (FIG. 2) substantially enclosing an electric motor, such as a brushless DC (BLDC) motor. Referring to FIG. 4, the first side wall 40 and second side wall 42 extend from an end cap portion 44 to a drive end 46. Referring to FIG. 1, a first end cap bumper 48 is coupled to the end cap portion 44 adjacent the first side wall 40. Referring to FIG. 4, the first end cap bumper 48 extends radially outward with respect to the driveline axis 16 a first bumper radius 52 from the driveline axis 16. Referring to FIG. 2, a second end cap bumper 54 is coupled to the end cap portion 44 adjacent the second side wall 42. Referring to FIG. 4, the second end cap bumper extends radially outward with respect to the driveline axis 16 a second bumper radius 58 from the driveline axis 16. The first end cap bumper 48 is disposed substantially opposite the second end cap bumper 54 with respect to the driveline axis 16, and the first end cap bumper 48 and second end cap bumper 54 each extend substantially perpendicular to the battery handle axis 26 and the driveline axis 16. The first and second end cap bumpers 48 and 54 may be formed of a resilient material.

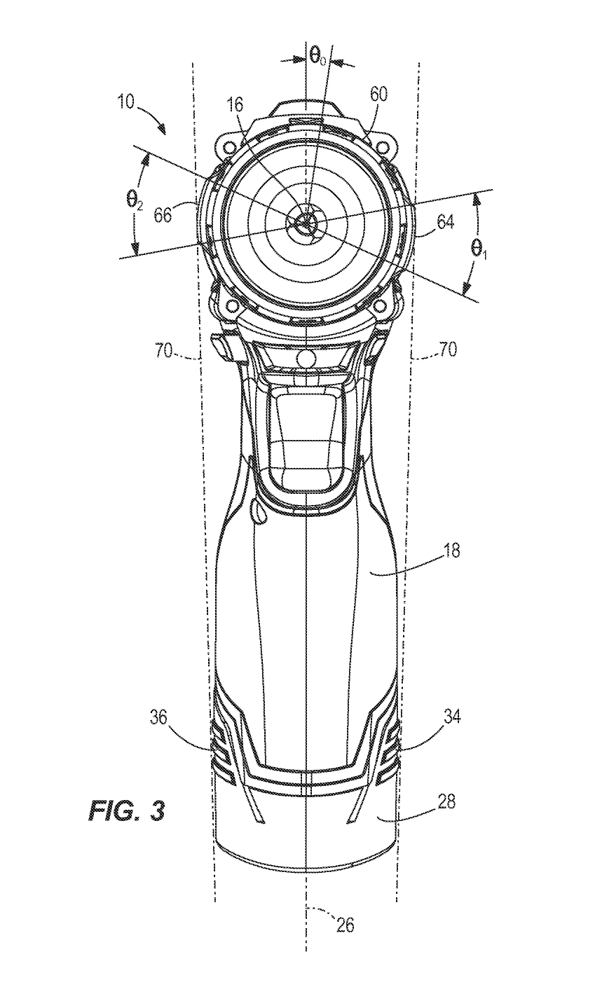

Referring to FIG. 2, a mode selector ring 60 and a torque selector ring 62 are rotatably coupled, about the driveline axis 16, to the housing assembly 14 between the chuck assembly 12 and the drive end 46. Referring to FIG. 3, the mode selector ring 60 has a limited angle of rotation θ₀ about the driveline axis, for selection between, for example, a drilling mode and a fastener driving mode. The angle of rotation θ₀ may be, for example, less than 30 degrees, more specifically less than 15 degrees, and even more specifically less than 10 degrees.

Referring to FIGS. 1 and 4, a first drive end bumper 64 extends radially outward from the mode selector ring 60 adjacent the first side wall 40, to approximately the first bumper radius 52. Referring to FIGS. 2 and 4, a second drive end bumper 66 extends radially outward from the mode selector ring 60, to approximately the second bumper radius 58. Referring to FIGS. 3 and 4, the first drive end bumper 64 is disposed substantially opposite the second drive end bumper 66 with respect to the driveline axis 16. Referring to FIG. 3, the first drive end bumper 64 and the second drive end bumper 66 each define a bumper angular length θ₁ and θ₂, which is greater than θ₀, such that a portion of each drive end bumper 64 and 66 extends substantially perpendicular to the handle axis 26 with the mode selector ring 60 in any position. The bumper angular lengths θ₁ and θ₂ may be, for example, between approximately 30 degrees and approximately 40 degrees, and more specifically, approximately 35 degrees.

The torque selector ring 62 is rotatably coupled to the housing assembly 14 between the mode selector ring 60 and the chuck assembly 12. Referring to FIG. 4, the torque selector ring 62 has a radius 68 less than the first bumper radius 52 and the second bumper radius 58.

Referring to FIGS. 3-4, the first drive end bumper 64, the first end cap bumper 48, and the first battery bumper 34 are coplanar. Similarly, the second drive end bumper 66, second end cap bumper 54, and second battery bumper 36 are coplanar. Therefore, the power tool 10 may be placed upon a flat surface, or plane, 70 (FIG. 3) with either only the first bumpers 34, 48 and 64 or the second bumpers 36, 54, and 66 in contact with the surface. In other words, the plane 70, as defined by the respective end cap bumper 48 and 54, the drive end bumper 64 and 66, and the battery bumpers 34 and 36, is not intersected by any other portion of the power tool 10. Where the bumpers are formed of a resilient material, the bumpers substantially inhibit the power tool 10 from sliding across, or marring, the surface upon which the drill is placed.

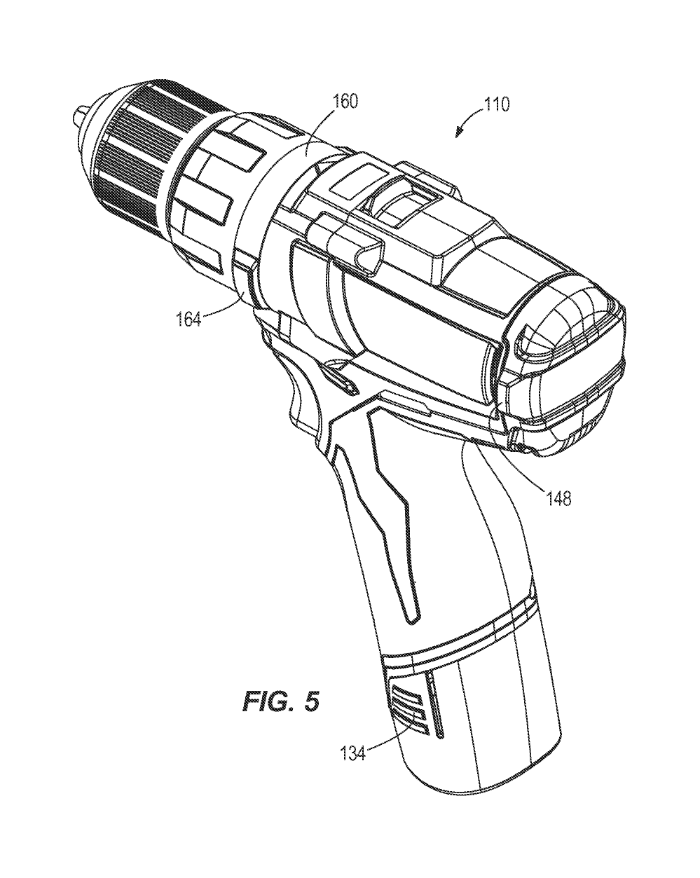

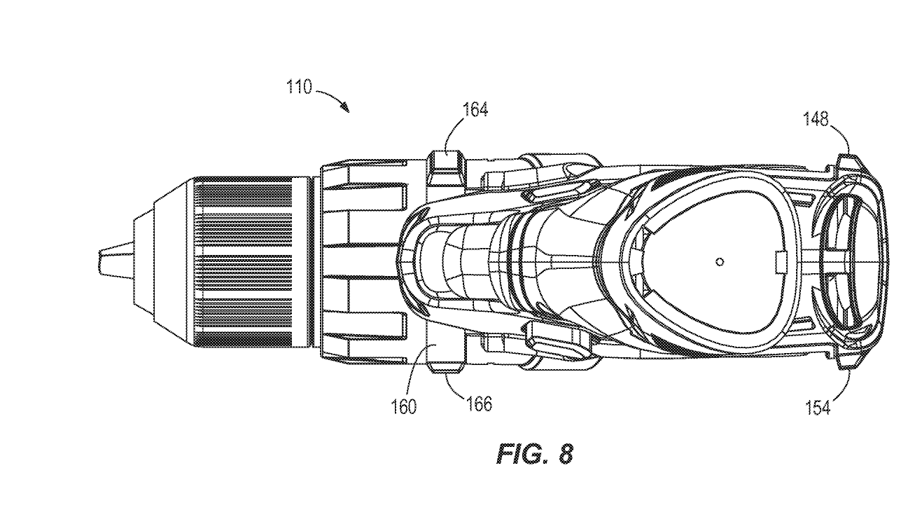

FIGS. 5-8 illustrate a power tool 110, such as, e.g., a hammer drill, according to another construction of the invention. Similar components to those identified with respect to the construction of FIGS. 1-4 have been given identical reference numerals, plus “100.” Only those features that differ from the construction of FIGS. 1-4 are described herein.

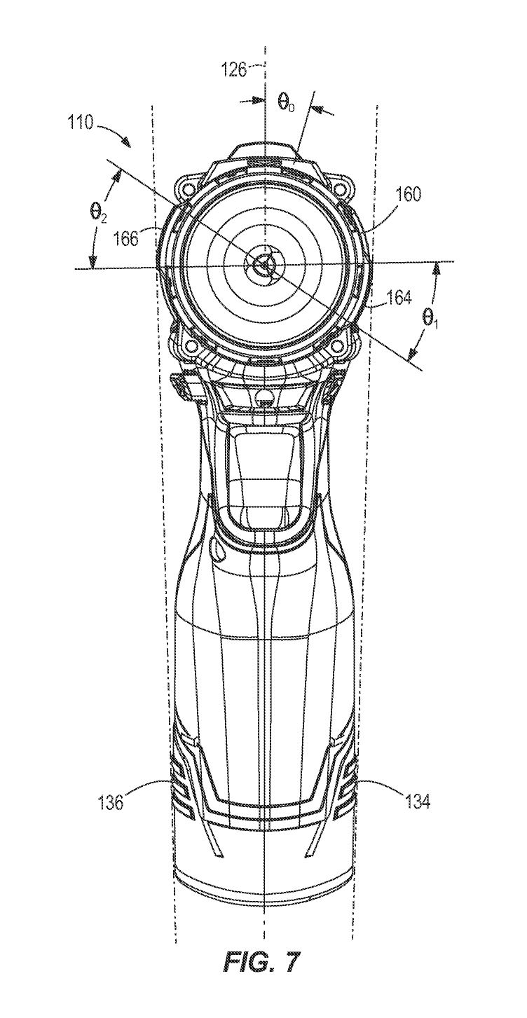

In particular, the power tool 110 includes a mode selector ring 160. The mode selector ring 160 has three positions including, for example, a hammer drilling position, a drilling position, and a driving position, with a limited angle of rotation θ₀ (FIG. 7), for selection between the three modes. The angle of rotation θ₀ may be less than 30 degrees, and more specifically, less than 15 degrees. A first drive end bumper 164 and a second drive end bumper 166 define bumper angular lengths θ₁ and θ₂ that may be, for example, between approximately 30 degrees and approximately 40 degrees, and more specifically, approximately 35 degrees. A portion of each drive end bumper 164 and 66 extends substantially perpendicular to a handle axis 126 with the mode selector ring 160 in any position (FIG. 7).

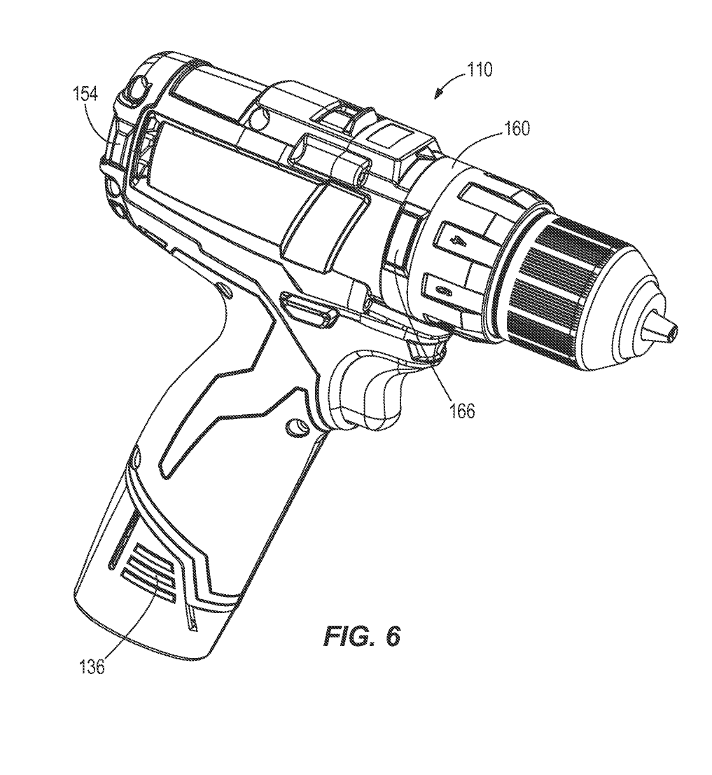

The power tool 110 may be placed upon a flat surface, or plane, 170 (FIG. 7) with either only first bumpers 134, 148 and 164 (FIG. 5) or second bumpers 136, 154, and 166 (FIG. 6) in contact with the surface. In other words, the plane 170, as defined by the respective end cap bumper 148 and 154, the drive end bumper 164 and 166, and the battery bumpers 134 and 136, is not intersected by any other portion of the power tool 110. Where the bumpers are formed of a resilient material, the bumpers substantially inhibit the power tool 110 from sliding across, or marring, the surface upon which the drill is placed.

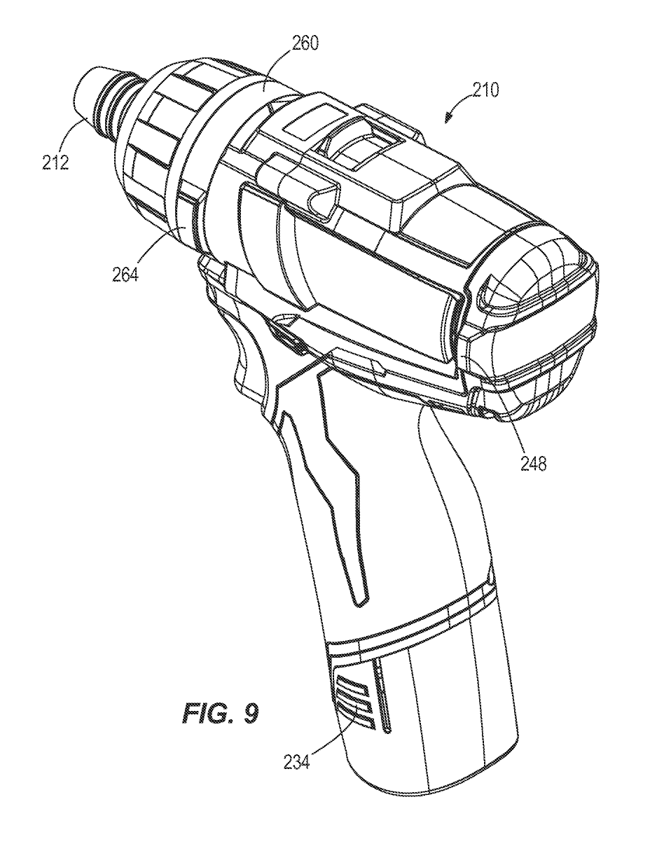

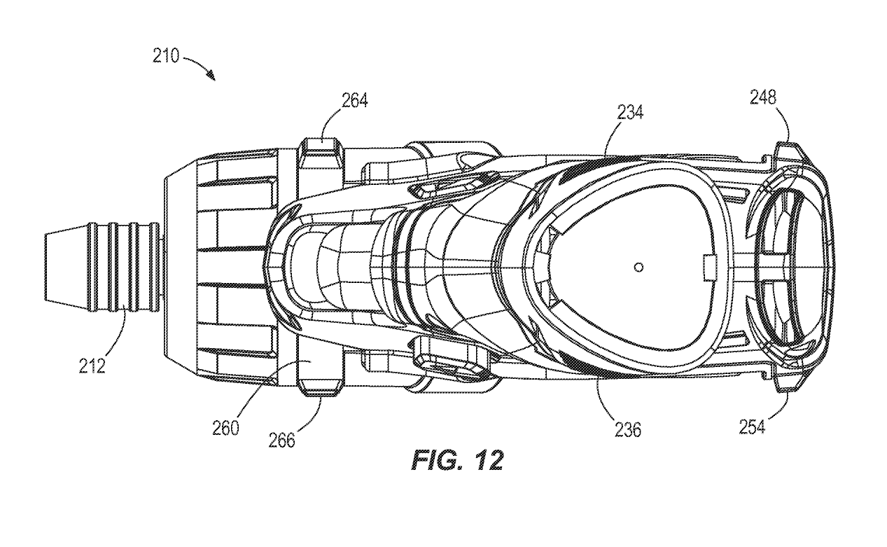

FIGS. 9-12 illustrate a power tool 210, such as, e.g., a power screwdriver, according to another construction of the invention. Similar components to those identified with respect to the construction of FIGS. 1-4 have been given identical reference numerals, plus “200.” Only those features that differ from the construction of FIGS. 1-4 are described herein.

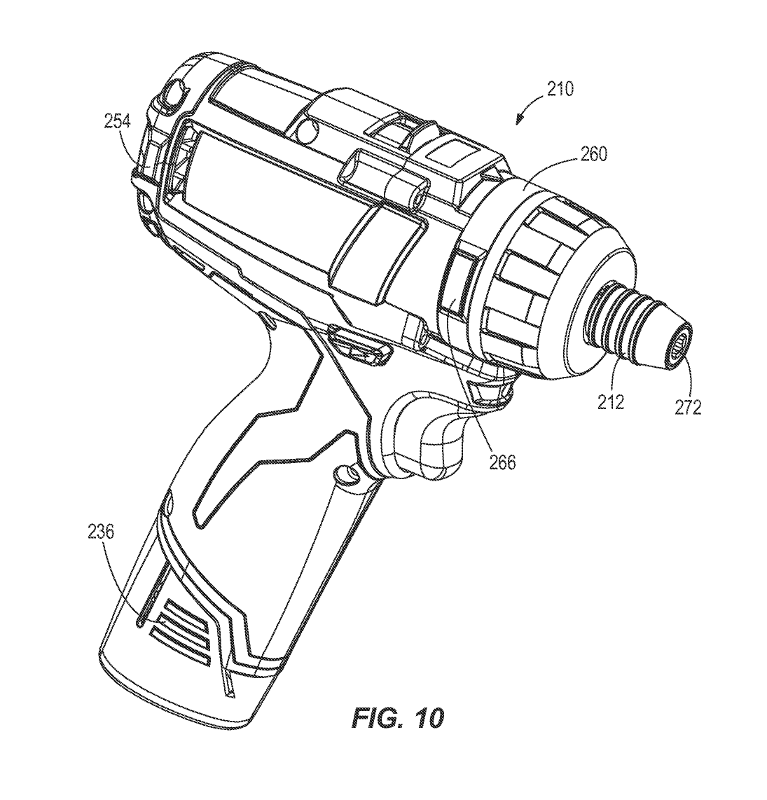

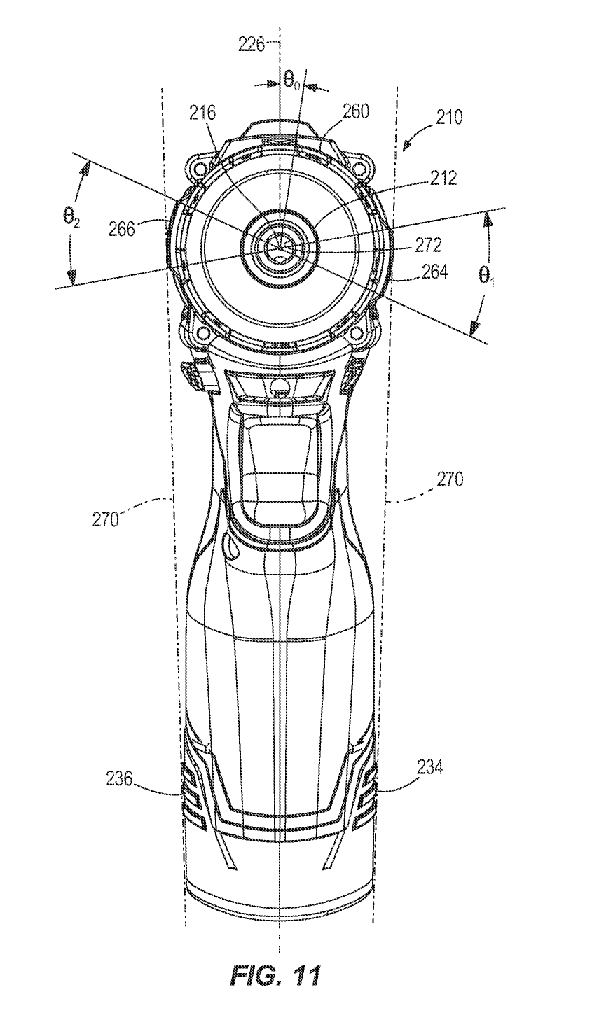

In particular, the power tool 210 includes a chuck assembly 212 having a quick release bit receptacle 272 (FIGS. 10 and 11). A mode selector ring 260 has two positions including, for example, a drilling position and a driving position, with a limited angle of rotation θ₀ (FIG. 11), for selection between the two modes. The angle of rotation θ₀ may be less than 30 degrees, more specifically less than 15 degrees, and even more specifically less than 10 degrees. A first drive end bumper 264 and a second drive end bumper 266 define bumper angular lengths θ₁ and θ₂ that may be, for example, between approximately 30 degrees and approximately 40 degrees, and more specifically, approximately 35 degrees. A portion of each drive end bumper 264 and 266 extends substantially perpendicular to a handle axis 226 with the mode selector ring 260 in any position (FIG. 11).

The power tool 210 may be placed upon a flat surface, or plane, 270 (FIG. 11) with either only first bumpers 234, 248 and 264 (FIG. 9) or second bumpers 236, 254, and 266 (FIG. 10) in contact with the surface. In other words, the plane 270, as defined by the respective end cap bumper 248 and 254, the drive end bumper 264 and 266, and the battery bumpers 234 and 236, is not intersected by any other portion of the power tool 210. Where the bumpers are formed of a resilient material, the bumpers substantially inhibit the power tool 210 from sliding across, or marring, the surface upon which the drill is placed.

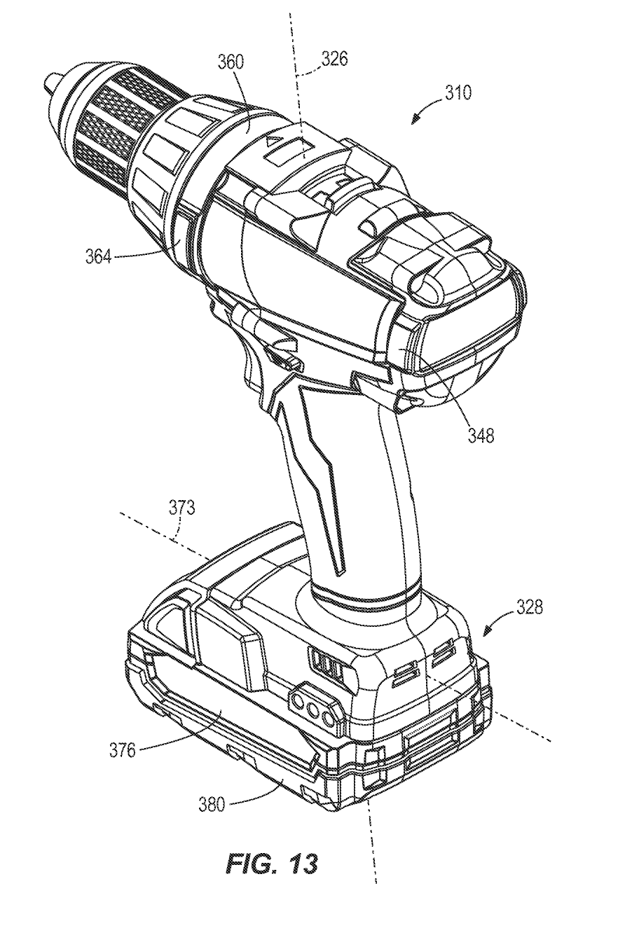

FIGS. 13-16 illustrate a power tool 310, such as, e.g., a drill driver, according to another construction of the invention. Similar components to those identified with respect to the construction of FIGS. 1-4 have been given identical reference numerals, plus “300.” Only those features that differ from the construction of FIGS. 1-4 are described herein.

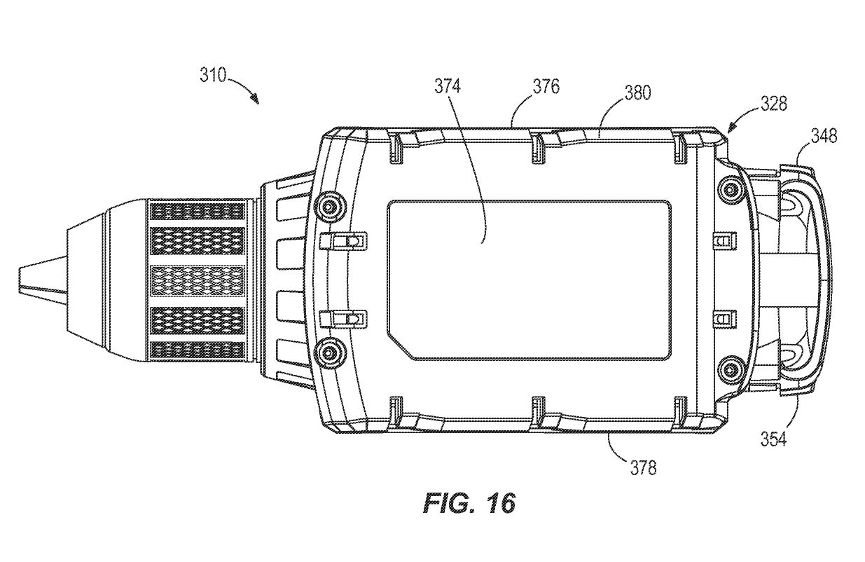

In particular, the power tool 310 is configured to receive a battery 328, such as, for example, an 18 volt, lithium-ion rechargeable battery pack, along a battery insertion axis 373 (FIG. 13) that is substantially perpendicular to a handle axis 326. Referring to FIG. 16, the battery 328 has a substantially rectangular base portion 374, with a first side wall 376 and a second side wall 378. A resilient battery bumper 380 extends over the base portion 374 and at least a portion of the first side wall 376 and second side wall 378.

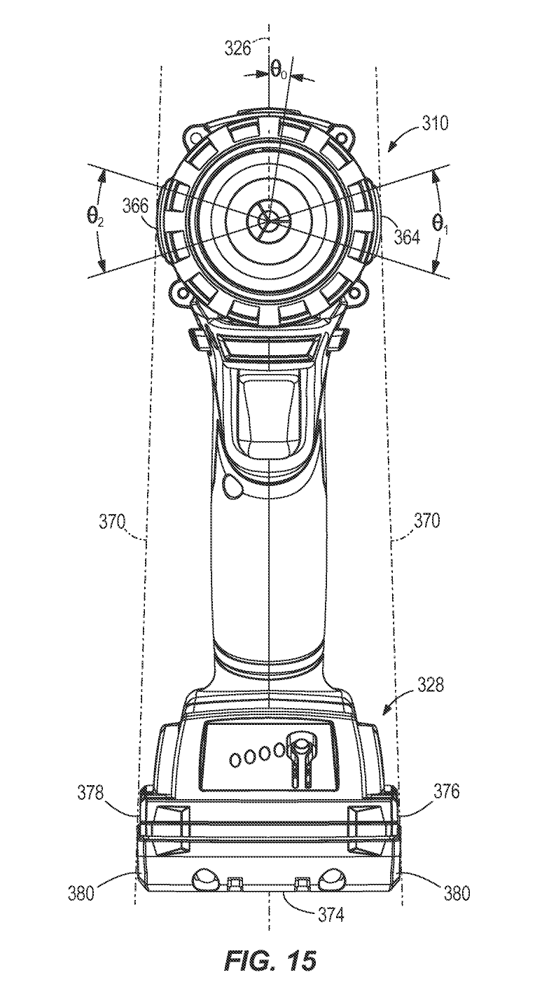

The power tool 310 includes a mode selector ring 360 that has two positions including, for example, a drilling position and a driving position, with a limited angle of rotation θ₀ (FIG. 15), for selection between the two modes. The angle of rotation θ₀ may be less than 30 degrees, more specifically, less than 15 degrees and even more specifically less than 10 degrees. A first drive end bumper 364 and a second drive end bumper 366 define bumper angular lengths θ₁ and θ₂ that may be, for example, between approximately 30 degrees and approximately 40 degrees, and more specifically, approximately 35 degrees. A portion of each drive end bumper 364 and 366 extends substantially perpendicular to a handle axis 326 with the mode selector ring 360 in any position.

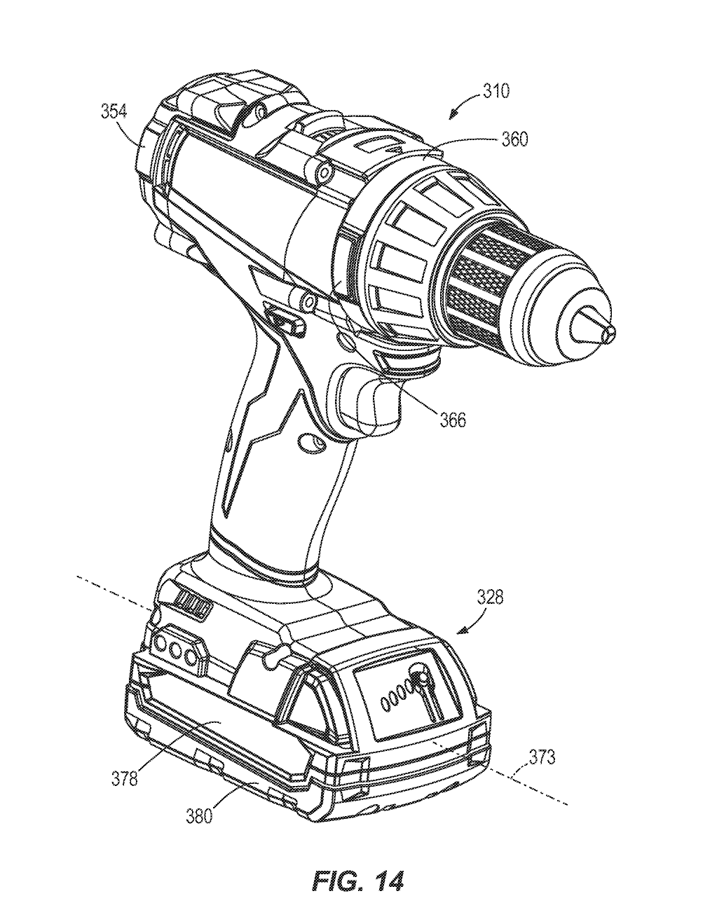

The power tool 310 may be placed upon a flat surface, or plane, 370 (FIG. 15) with only the battery bumper 380 and either first bumpers 348 and 364 (FIG. 13) or second bumpers 354 and 366 (FIG. 14) in contact with the surface. In other words, the plane 370, as defined by a respective end cap bumper 348 and 354, the drive end bumper 364 and 366, and sides 376 and 378 of the battery bumpers 380, is not intersected by any other portion of the power tool 310. Where the bumpers are formed of a resilient material, the bumpers substantially inhibit the power tool 310 from sliding across, or marring, the surface upon which the drill is placed.

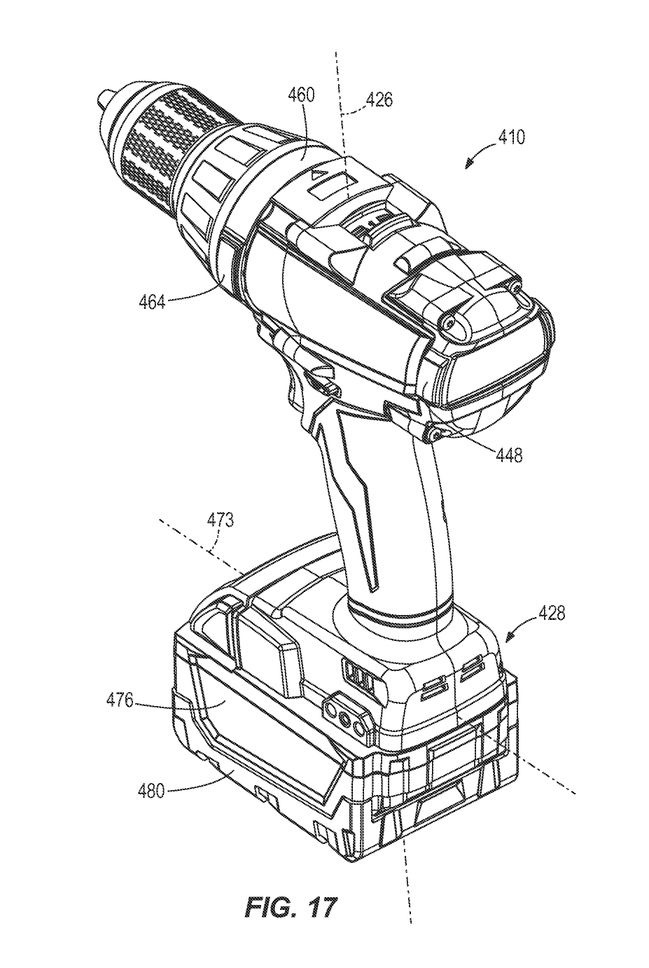

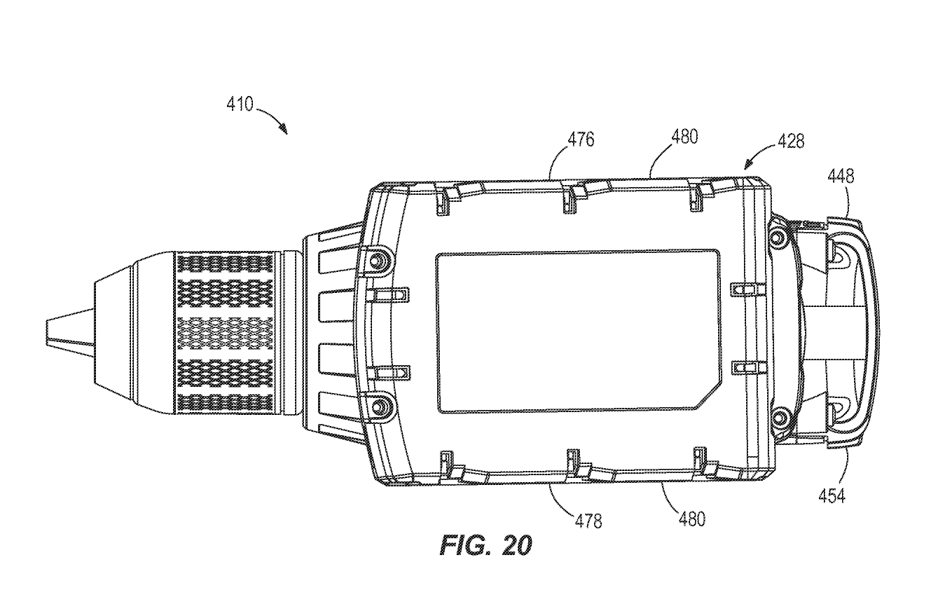

FIGS. 17-20 illustrate a power tool 410, such as, e.g., a hammer drill, according to another construction of the invention. Similar components to those identified with respect to the construction of FIGS. 1-4 have been given identical reference numerals, plus “400.” Only those features that differ from the construction of FIGS. 1-4 are described herein.

The power tool 410 utilizes a high capacity 18 volt battery pack 428 that is larger than, but otherwise similar to, the battery pack 328 described with respect to the power tool 310. The battery pack includes a battery bumper 480 and is received along a battery insertion axis 473 that is substantially perpendicular to a handle axis 426.

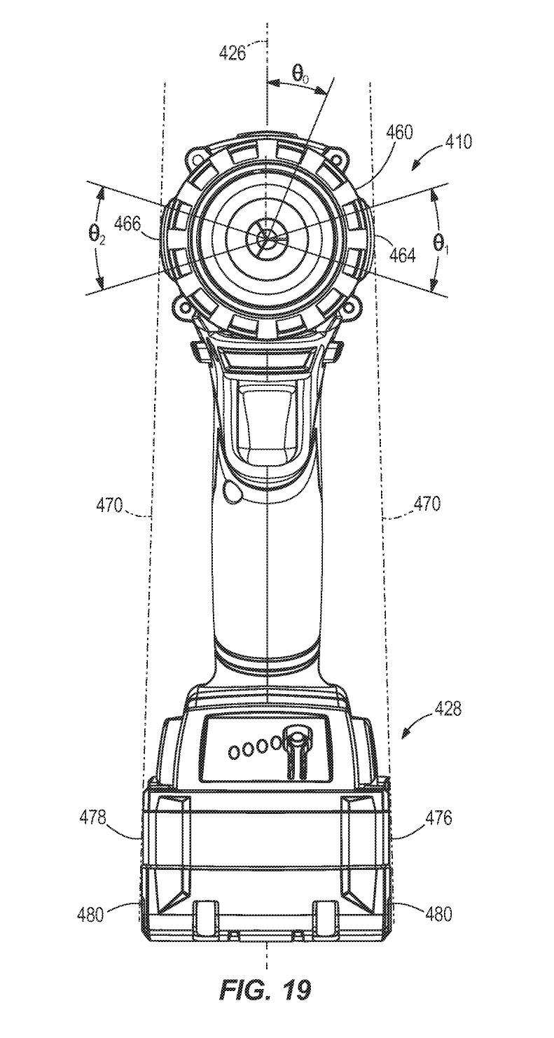

In addition, the power tool 410 includes a three position mode selector ring 460. The mode selector ring 460 has three positions: a hammer drilling position, a drill position, and a driving position, with a limited angle of rotation θ₀ (FIG. 19), for selection between the three modes. The angle of rotation θ₀ may be less than 30 degrees, and more specifically, less than 15 degrees. A first drive end bumper 464 and a second drive end bumper 466 define bumper angular lengths θ₁ and θ₂ that may be, for example, between approximately 30 degrees and approximately 40 degrees, and more specifically, approximately 35 degrees. A portion of each drive end bumper 464 and 466 extends substantially perpendicular to a handle axis 426 with the mode selector ring 460 in any position (FIG. 19).

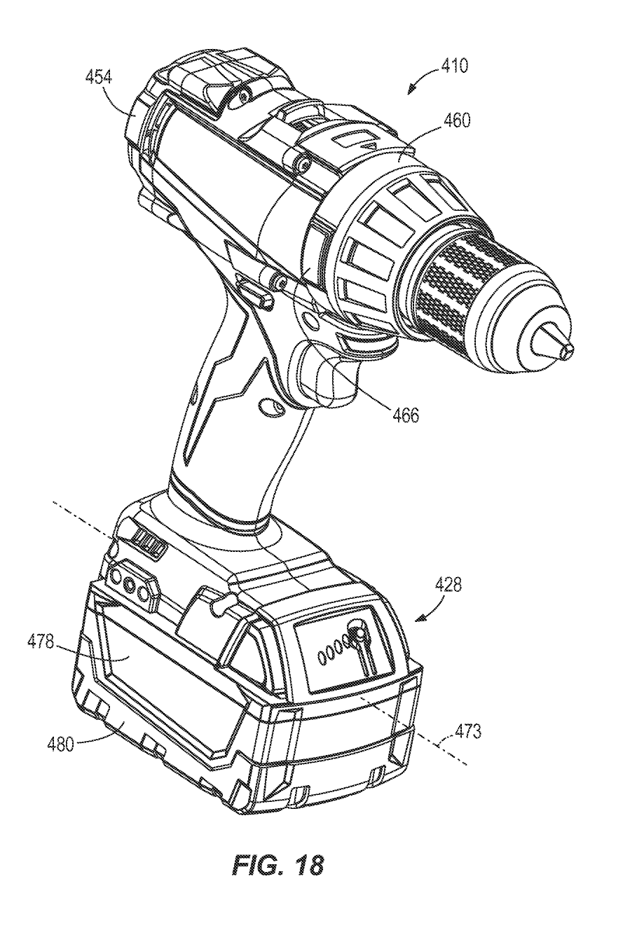

The power tool 410 may be placed upon a flat surface, or plane, 470 with only the battery bumper 480 and either only first bumpers 448 and 464 (FIG. 17) or second bumpers 454 and 466 (FIG. 18) in contact with the surface. In other words, the plane 470, as defined by a respective end cap bumper 448 and 454, the drive end bumper 464 and 466, and sides 476 and 478 of the battery bumpers 480, is not intersected by any other portion of the power tool 410. Where the bumpers are formed of a resilient material, the bumpers substantially inhibit the power tool 410 from sliding across, or marring, the surface upon which the drill is placed.

Thus, the invention provides, among other things, a power tool housing with a bumper arrangement. Although the invention has been described in detail with reference to certain preferred embodiments, variations and modifications exist within the scope and spirit of one or more independent aspects of the invention as described. Various features and advantages of the invention are set forth in the following claims.

What is claimed is:

1. A power tool, comprising:
a chuck assembly defining a driveline axis;
a housing assembly rotatably supporting the chuck assembly and including
a handle portion disposed along a handle axis and defining a battery receptacle, and
a motor housing portion including a side wall extending from an end cap portion to a drive end;
an end cap bumper coupled to the end cap portion adjacent the side wall and extending radially outward with respect to the driveline axis;
a mode selector ring is rotatably coupled to the housing assembly about the driveline axis, between the chuck assembly and the motor housing portion drive end;
a drive end bumper coupled to the mode selector ring and extending radially outward with respect to the driveline axis from the mode selector ring; and
a battery pack at least partially received by the battery receptacle, the battery pack having a base portion including a battery bumper member extending radially outward from the handle axis, wherein a plane defined by the end cap bumper, the drive end bumper, and the battery bumper is not intersected by any other portion of the power tool.

2. The power tool of claim 1, wherein the mode selector ring is rotatable between a first position and a second position, with an angle of rotation about the driveline axis defined between the first position and the second position, and further wherein the drive end bumper defines a bumper angular length greater than the angle of rotation such that a portion of the drive end bumper extends substantially perpendicular to the handle axis with the mode selector ring in any position.

3. The power tool of claim 2, wherein drive end bumper comprises a first drive end bumper and a second drive end bumper disposed substantially opposite the first drive end bumper with respect to the driveline axis, each of the first drive end bumper and second drive end bumper having a bumper angular length greater than the angle of rotation.

4. The power tool of claim 2, wherein the mode selector ring selects a first operating mode of the power tool in the first position and a second operating mode of the power tool in the second position.

5. The power tool of claim 4, wherein the mode selector ring is rotable to a third position between the first position and the second position, the third position corresponding to a third operating mode of the power tool.

6. The power tool of claim 1, wherein drive end bumper comprises a first drive end bumper and a second drive end bumper disposed substantially opposite the second drive end bumper.

7. The power tool of claim 1, wherein end cap bumper and drive end bumper each extend radially outward with respect to the driveline axis to a first bumper radius.

8. The power tool of claim 1, wherein the base portion of the battery pack is contoured to matingly engage corresponding contours of an end portion of the housing handle portion.

9. The power tool of claim 1, wherein the battery bumper member comprises a first battery bumper and a second battery bumper coupled to the base portion.

10. The power tool of claim 9, wherein the first battery bumper and second battery bumper each extend substantially perpendicular to the battery handle axis and the driveline axis.

11. The power tool of claim 10, wherein the first battery bumper is disposed substantially opposite the second battery bumper with respect to the battery handle axis.

12. The power tool of claim 1, wherein the battery receptacle is oriented along the handle axis.

13. The power tool of claim 1, further comprising a torque selector ring rotatably coupled about the driveline axis between the chuck assembly and mode selector ring.

14. A power tool, comprising:
a chuck assembly defining a driveline axis;
a motor housing rotatably supporting the chuck assembly and extending from an end cap portion to a drive end, the end cap portion including an end cap bumper extending radially outward with respect to the driveline axis;
a handle extending from the motor housing along a handle axis and defining a battery receptacle for receiving a battery pack; and
a mode selector ring rotatably coupled to the housing assembly about the driveline axis between the chuck assembly and the motor housing drive end, the mode selector ring including a drive end bumper extending radially outward with respect to the driveline axis, wherein the power tool may rest upon a flat surface with only the end cap bumper and drive end bumper contacting the surface when a battery pack is inserted into the battery receptacle.

15. The power tool of claim 14, wherein the mode selector ring is rotatable between a first position and a second position, with a limited angle of rotation about the driveline axis defined between the first position and the second position, and further wherein the drive end bumper defines a bumper angular length greater than the angle of rotation, such that a portion of the drive end bumper extends substantially perpendicular to the handle axis with the mode selector ring in any position.

16. The power tool of claim 15, wherein drive end bumper comprises a first drive end bumper and a second drive end bumper disposed substantially opposite the second drive end bumper with respect to the driveline axis, each of the first drive end bumper and second drive end bumper having a bumper angular length greater than the angle of rotation.

17. The power tool of claim 15, wherein the mode selector ring selects a first operating mode of the power tool in the first position and a second operating mode of the power tool in the second position.

18. The power tool of claim 15, wherein the mode selector ring is rotatable to a third position between the first position and the second position, the third position corresponding to a third operating mode of the power tool.

19. The power tool of claim 14, wherein the drive end bumper comprises a first drive end bumper and a second drive end bumper disposed substantially opposite the first drive end bumper.

20. The power tool of claim 14, wherein the end cap bumper and the drive end bumper each extend radially outward with respect to the driveline axis to a first bumper radius.
